(19) United States
(12) Patent Application Publication
(10) Pub. No.: US 2010/0241539 A1
(43) Pub. Date: Sep. 23, 2010

(54) Method and system of managing a borrower's loan obligations

(76) Inventor: Barry Thomas Baker, Eagle, ID (US)

Correspondence Address: Barry Baker, 624 N. Clearpoint Way, Eagle, ID, 83616, US

(21) Appl. No.: 12/660,975

(22) Filed: Mar. 8, 2010

Related U.S. Application Data
(60) Provisional application No. 61/210,423, filed on Mar. 18, 2009.

(51) Int. Cl. G06Q 40/00; G06Q 30/00; G06Q 10/00

(52) U.S. Cl. 705/34; 705/38; 705/40

(57) ABSTRACT

A method, management system, and management information system operated and maintained by a borrower for the plurality of its loan obligations in the form of a computer software system and database wherein the a borrower's loan transactions are recorded in the system and retained in the database for the plurality of its loans while exporting accounting entries to the borrower's other financial systems. Periodic interest is calculated by the system for verification against the lender's calculation. Payments of principal, accrued interest and escrow amounts are calculated and initiated for payment to a borrower's plurality of lenders by the system. The system retains a current balance for outstanding principal balance, accrued interest, escrow accounts, lender's commitment to lend and remaining interest reserve for each of a borrower's loan obligations. The system manages every practical method of loan servicing as commonly practiced in real estate lending and other industries.

### CROSS-REFERENCE TO RELATED APPLICATIONS

This application is based on U.S. patent application Ser. No. 61/210,423, filed Mar. 18, 2009, titled METHOD AND SYSTEM OF MANAGING A BORROWER'S LOAN OBLIGATIONS, the entire disclosure of which is hereby incorporated by reference.

### STATEMENT REGARDING FEDERALLY SPONSORED RESEARCH OR DEVELOPMENT

Not Applicable

### REFERENCE TO A COMPUTER PROGRAM LISTING APPENDIX

A computer program listing appendix on compact disc is included in the application and the material on the compact disc is incorporated into this application by reference. The files included on the compact disc contain all of the source code for the present invention. The disc labeled COPY 1—COMPUTER PROGRAM LISTING APPENDIX contains the following files:

| File Name | Creation Date | File Size |
|---|---|---|
| ModVoidTransactions.bas | 03/02/2010 | 13,879 |
| ModVerification.bas | 03/02/2010 | 9,896 |
| ModUtility.bas | 03/02/2010 | 28,813 |
| ModRibbonCallbacks.bas | 03/02/2010 | 62,892 |
| ModRestartDatabase.bas | 03/02/2010 | 19,860 |
| ModPortfolioCalculations.bas | 03/02/2010 | 17,274 |
| ModPaymentCalculations.bas | 03/02/2010 | 48,485 |
| ModParity.bas | 03/02/2010 | 16,882 |
| ModNoteCreator.bas | 03/02/2010 | 25,958 |
| ModInterestDispute.bas | 03/02/2010 | 20,049 |
| ModClosePeriod.bas | 03/02/2010 | 31,223 |
| ModConnection.bas | 03/02/2010 | 27,440 |
| ModErrorHandling.bas | 03/02/2010 | 6,571 |
| ModGlobals.bas | 03/02/2010 | 1,905 |
| ModIndexTables.bas | 03/02/2010 | 11,859 |
| ModIntegration.bas | 03/02/2010 | 76,688 |
| ModInterestCalculations.bas | 03/02/2010 | 67,396 |
| ModAmortization.bas | 03/02/2010 | 77,707 |
| Form_frmClosePeriod.cls | 03/02/2010 | 5,384 |
| Form_frmCommitment.cls | 03/02/2010 | 5,390 |
| Form_frmConnectionSettings.cls | 03/02/2010 | 5,792 |
| Form_frmCreateNote.cls | 03/02/2010 | 1,965 |
| Form_frmCurrentPortionSel.cls | 03/02/2010 | 2,153 |
| Form_frmDateAdjustLoanSelect.cls | 03/02/2010 | 3,005 |
| Form_frmDateAdjustSelect.cls | 03/02/2010 | 4,021 |
| Form_frmDispute.cls | 03/02/2010 | 4,153 |
| Form_frmEditRates.cls | 03/02/2010 | 3,831 |
| Form_frmEscPaymentSelect.cls | 03/02/2010 | 2,265 |
| Form_frmEscPmtDateAdjust.cls | 03/02/2010 | 7,443 |
| Form_frmEscrowAdj.cls | 03/02/2010 | 12,315 |
| Form_frmEscrowAdjSelect.cls | 03/02/2010 | 1,142 |
| Form_frmEscrowPayment.cls | 03/02/2010 | 10,015 |
| Form_frmFFPayment.cls | 03/02/2010 | 19,815 |
| Form_frmFFPaymentSelect.cls | 03/02/2010 | 2,260 |
| Form_frmIndexTables.cls | 03/02/2010 | 2,987 |
| Form_frmClientSettings.cls | 03/02/2010 | 2,226 |
| Form_frmLenders.cls | 03/02/2010 | 7,467 |
| Form_frmLoanActivation.cls | 03/02/2010 | 26,829 |
| Form_frmLoanPayoff.cls | 03/02/2010 | 8,108 |
| Form_frmLoanReportSelect.cls | 03/02/2010 | 991 |
| Form_frmLoans.cls | 03/02/2010 | 18,678 |
| Form_frmLoanTypes.cls | 03/02/2010 | 4,938 |
| Form_frmLOC.cls | 03/02/2010 | 10,062 |
| Form_frmLOCAdd.cls | 03/02/2010 | 11,902 |
| Form_frmManInterestAdjust.cls | 03/02/2010 | 3,993 |
| Form_frmManPostInterest.cls | 03/02/2010 | 14,231 |
| Form_frmPayment.cls | 03/02/2010 | 18,178 |
| Form_frmPaymentSelect.cls | 03/02/2010 | 4,938 |
| Form_frmPmtDateAdjust.cls | 03/02/2010 | 7,521 |
| Form_frmPortFilter.cls | 03/02/2010 | 1,344 |
| Form_frmPortfolios.cls | 03/02/2010 | 9,056 |
| Form_frmPostInterest.cls | 03/02/2010 | 10,955 |
| Form_frmPrincipal.cls | 03/02/2010 | 10,448 |
| Form_frmProjects.cls | 03/02/2010 | 12,285 |
| Form_frmRebuildBalances.cls | 03/02/2010 | 2,832 |
| Form_frmRestore.cls | 03/02/2010 | 6,262 |
| Form_frmSettingsIntegrate.cls | 03/02/2010 | 2,102 |
| Form_frmSwaps.cls | 03/02/2010 | 11,904 |
| Form_frmSystemSettings.cls | 03/02/2010 | 2,470 |
| Form_frmUpdateIndexes.cls | 03/02/2010 | 6,332 |
| Form_frmVoidEscLoanSelect.cls | 03/02/2010 | 2,306 |
| Form_frmVoidEscrowSelect.cls | 03/02/2010 | 3,843 |
| Form_frmVoidLoanSelect.cls | 03/02/2010 | 2,382 |
| Form_frmVoidSelect.cls | 03/02/2010 | 6,683 |
| Form_frmChangePeriod.cls | 03/02/2010 | 6,610 |
| Form_frmBudgetSelect.cls | 03/02/2010 | 2,031 |
| Form_frmBorrowers.cls | 03/02/2010 | 6,981 |
| Form_frmBalances.cls | 03/02/2010 | 6,761 |
| Form_frmBackup.cls | 03/02/2010 | 4,955 |
| Form_frmAdjAdvDate.cls | 03/02/2010 | 8,128 |
| Form_frm1099.cls | 03/02/2010 | 8,327 |
| Form_frmInterestAdjust.cls | 03/02/2010 | 2,762 |
| IsItLinked.sql | 03/02/2010 | 905 |
| GetSQLVersion.sql | 03/02/2010 | 2,412 |
| GetPeriodEndDate.sql | 03/02/2010 | 847 |
| GetPeriodBegDate.sql | 03/02/2010 | 854 |
| GetNextPostDate.sql | 03/02/2010 | 3,152 |
| GetCurrentDebtService.sql | 03/02/2010 | 1,564 |
| GetAnnualDebtService.sql | 03/02/2010 | 6,242 |
| totalpayment.sql | 03/02/2010 | 1,118 |
| IsItPaidOff.sql | 03/02/2010 | 883 |
| TotalEscrow.sql | 03/02/2010 | 1,244 |
| DiffDays.sql | 03/02/2010 | 903 |
| DeleteDatabase.sql | 03/02/2010 | 1,562 |
| CreateNewDatabase.sql | 03/02/2010 | 6,480 |
| ConvertReference.sql | 03/02/2010 | 1,410 |
| CalcEffectiveRate.sql | 03/02/2010 | 2,648 |
| BuildDate.sql | 03/02/2010 | 900 |
| BackupDatabase.sql | 03/02/2010 | 1,664 |
| ReportDays.sql | 03/02/2010 | 943 |
| RestoreDatabaseCreate.sql | 03/02/2010 | 5,562 |
| RestoreDatabaseReplace.sql | 03/02/2010 | 5,954 |
| ReverseTheSign.sql | 03/02/2010 | 1,316 |
| RunlmportBatchFile.sql | 03/02/2010 | 1,386 |
| SetCompoundDate.sql | 03/02/2010 | 1,555 |
| SetToDateIfNull.sql | 03/02/2010 | 993 |
| transfertexttoindexes.sql | 03/02/2010 | 1,011 |

### BACKGROUND OF THE INVENTION

The present invention relates to the management of a borrower's plurality of loan obligations. More particularly, the present invention is a computer software system and database designed to operate on the “front end” of the borrower's other systems such as its general ledger, accounts payable, and job cost systems. The present invention provides the borrower the ability to have the same information as that contained by its plurality of lenders or loan servicers. The invention will check and offer suggested corrections to the interest calculations made by the plurality of loans servicers on a plurality of differing types of loans. The present invention contains a single repository for all the data related to the borrower's loan obligations including transactions and balances. The present invention rolls up its loans obligations to an asset level and then to a portfolio level providing the borrower the opportunity to track key performance indicators over time.

Common practice in lending in general and in the real estate industry in particular, each lender may vary its lending practices to suit its own particular loan servicing system. Loans can and do vary in a number of possible of ways:
1. Interest
   a. Fixed interest rate for the life of the loan
   b. Variable interest rate
      i. Set to an index such as the Prime Lending Rate charged by banks or by an index such as the London Inter Bank Offering Rate (hereinafter LIBOR)
      ii. Reset on a particular day of the month or reset each day when the index rate changes
   c. A combination of a fixed interest rate for a portion of the life of the loan switching to a variable rate
   d. A combination of a variable interest rate for a portion of the life of the loan switching to a fixed rate
   e. Interest can compound over a range of periods such as monthly, quarterly, semi-annually or annually.
   f. The Compounding Period can end on any day of the calendar month.
   g. Interest can be paid current so that interest accrues until interest is paid.
   h. Interest can be simple; that is interest will not accrue on unpaid interest
2. Payments of principal, interest, and escrow
   a. Interest only
   b. Interest may be unpaid and accrue as principal
   c. Principal can be paid in arrears; that is if the loan is not simple interest will not accrue on the unpaid principal
   d. Fixed principal and interest payment in total with the principal amortized over a certain period
   e. Variable payments with a fixed principal payment with a varying interest payment
   f. A “balloon” payment of principal at the end of the life of the loan.
   g. Interest may be paid from an interest reserve set up by the lender and be added to the principal balance of the loan
   h. The lender may require one or more escrow accounts that the borrower pays into to insure that payments such as real property taxes, insurance, capital reserves and the like are paid in full and on time.
3. Commitments, Letters of Credit, and Interest Reserve
   a. Lenders, as in construction or development lending, may make a plurality of advances of principal against the loan up to a specified limit commonly known as the commitment.
   b. Letters of credit may be issued by the lender on behalf of the borrower to a third party beneficiary. The value of the letter of credit limits the amount of commitment available for the borrower to advance against.
   c. Lenders, as in construction or development lending, may set up an interest reserve for the borrower to pay the current interest due. The interest is then added to the principal balance of the loan.
   d. Commitment issued by a lender may revolve as in lines of credit.

Given this environment of varying types of loans and lending practices, borrowers tend to create a plurality of management systems to capture the data generated in the compliance of the loan obligations. Those systems might include:
1. A General Ledger accounting system that could contain an account for the principal balance, the accrued interest, the interest expense, and any escrow accounts.
2. A spreadsheet or other tracking method to track the remaining Commitment available to the borrower.
3. A spreadsheet or other tracking method to track the remaining Interest Reserve available to the borrower.
4. A spreadsheet or other tracking method to track the any outstanding Letters of Credit which will limit the Commitment available to the borrower.
5. A spreadsheet or other tracking method to track assimilate all of the borrower's loan obligations in one place so that loan maturities, interest rates, payment dates, and other loan details can be viewed by management in one place.
6. A recurring payment record set up in the Accounts Payable system so that it is not necessary to re-type at every payment period the payment information.

Common practice in accrual basis loan accounting, in general and real estate particularly, borrowers typically:
1. For loans with a scheduled periodic payment, borrowers will record the interest due from the prior month in the month in which the payment is due at the time the payment is recorded in the Accounts Payable system.
2. For loans with a periodic payment, borrowers will then record a general journal entry to record the interest liability due at the end of a fiscal liability in accordance with Generally Accepted Accounting Principles (hereinafter GAAP) and then reverse the entry in the first period of the new fiscal accounting year.
3. For loans without a scheduled periodic payment, the borrower will generally record a general journal entry to reflect the interest liability in the correct month.
4. Generally, borrowers accept as accurate without verification the billing statement of principal, interest, and escrow amounts provided by the plurality of loan servicers for its plurality of loans. At times, the statements received from the lenders or servicers do not contain enough information for the borrower to replicate the calculation with ease.
5. When the lender or servicer's statement is received by the borrower, the information regarding the payment is entered into the borrower's accounts payable system for the issuance of a check, auto debit, or ACH.

The borrower in its compliance with its loan obligations and management of the same, it will often do a variety of tasks many different times and in many different systems.

### OBJECTS AND SUMMARY OF THE INVENTION

The principal object of the present invention is to provide one single database repository for all the information relating the borrower's plurality of loan obligations. The borrower will initiate all loan transactions in the present invention which will keep current the balances for principal, accrued interest, remaining commitment, remaining interest reserve, and escrow balances. The present invention stores and manages the borrower's letters of credit and their limiting affect on the loan commitment. The present invention is capable of storing in electronic form all loan documents for each of the borrower's plurality of loan obligations.

Because it is necessary to always keep the data in the present invention “live” or as up to date as the lender or servicer's database, the present invention creates the general journal entries and accounts payable entries to automatically import into the borrower's other accounting systems such as the general ledger, accounts payable, and job cost systems.

An ancillary objective of the present invention is to perform its own calculation of the interest due for all of the borrower's varying plurality of loans. With the present invention, the borrower may accept either the lender's calculation of interest or that calculated by the present invention. The present invention provides a basis for objecting to a lender's calculation of interest.

Another ancillary objective of the present invention, as it relates to the real estate and other asset based industries, the borrower can input the details of its assets contained in its portfolio such as type, value, net operating income, etc. Because loan balances, interest rates, payments are kept in one repository with the ability to access their history, the borrower can track by loan, project or by portfolio performance measures over time such as Equity, Cash Flow, Loan-to-Value, Debt Service Coverage Ratios, Return on Equity, Return on Assets, Weighted Average Cost of Capital, and a quantitative measure of financial leverage.

Another ancillary objective of the present invention is for the borrower to create its own promissory note documents using the stored attribute data in the database for a singular loan of the borrower's plurality of loans. It is common practice, as it relates to the real estate industry, that a borrower would prepare its own internal promissory note forms and service them internally with the present invention in the exact fashion as they were written. For example, the borrower can create notes to the borrower's shareholders or members and intercompany notes.

### BRIEF DESCRIPTION OF THE DRAWINGS

FIG. 1A is an overall block diagram of the flow of the interest calculations into the present invention.

FIG. 1B is an overall block diagram of the flow of the loan payment process in the present invention.

FIG. 2 is an overall block diagram of the flow of a payment of interest and/or principal in the current art.

FIG. 3 is an overall flow chart of the algorithm used by the present invention to calculate interest.

FIG. 4 is a flow chart illustrating the loading of an interest rate array to apply changes in interest rates to an interest calculation in the case of variable rate loans.

FIG. 5 is a flow chart illustrating the method the present invention uses to calculate the beginning principal balance for which to make the interest calculations.

FIG. 6 is a flow chart illustrating the process in which principal and/or interest payments are initiated within the present invention.

FIG. 7 is a graphic that illustrates the method in which loans are linked to Projects and Projects are linked to Portfolios.

FIG. 8 is a flow chart illustrating the process in which a borrower activates a loan in the present invention.

FIG. 9 is a flow chart illustrating the process in which a borrower pays off a loan in the present invention.

FIG. 10A is a flow chart illustrating the process of adding a letter of credit in the present invention.

FIG. 10B is a flow chart illustrating the process of releasing a letter of credit in the present invention.

FIG. 11 is a flow chart illustrating the flow of information for a user to translate stored information regarding a singular loan to create a promissory note form in a text format.

FIG. 12 illustrates the basic database architecture of the present invention.

### DETAILED DESCRIPTION OF EMBODIMENTS OF THE INVENTION

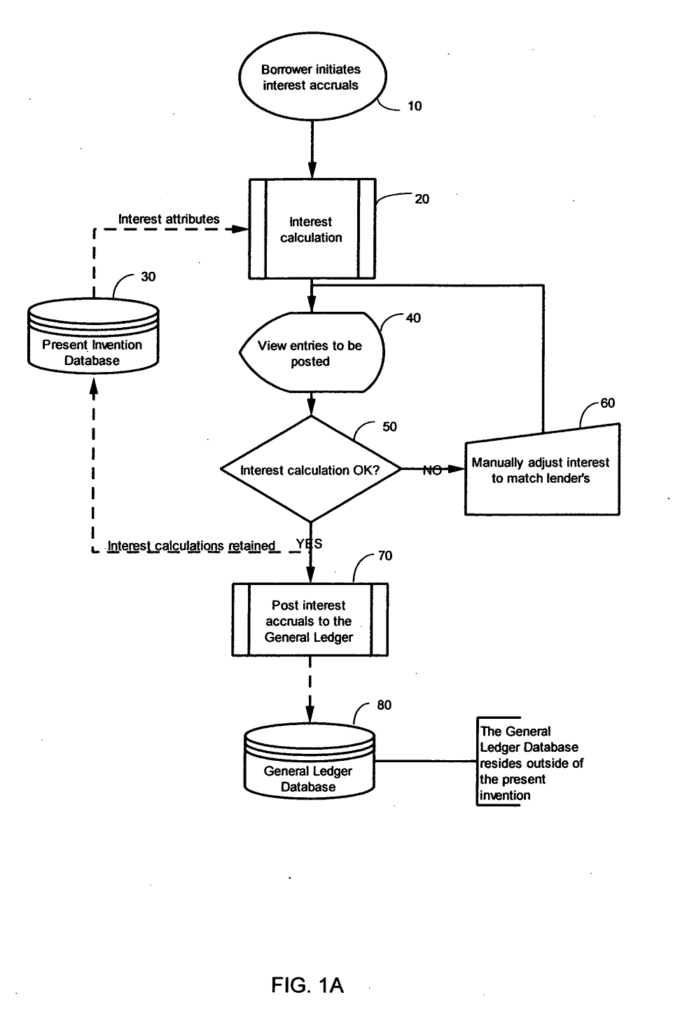

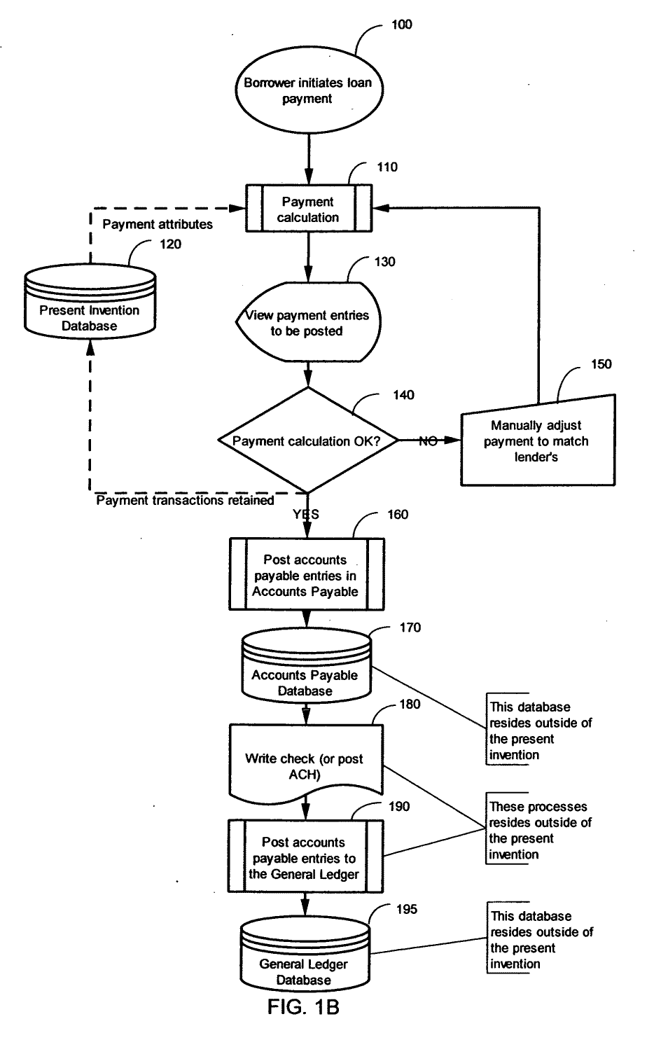

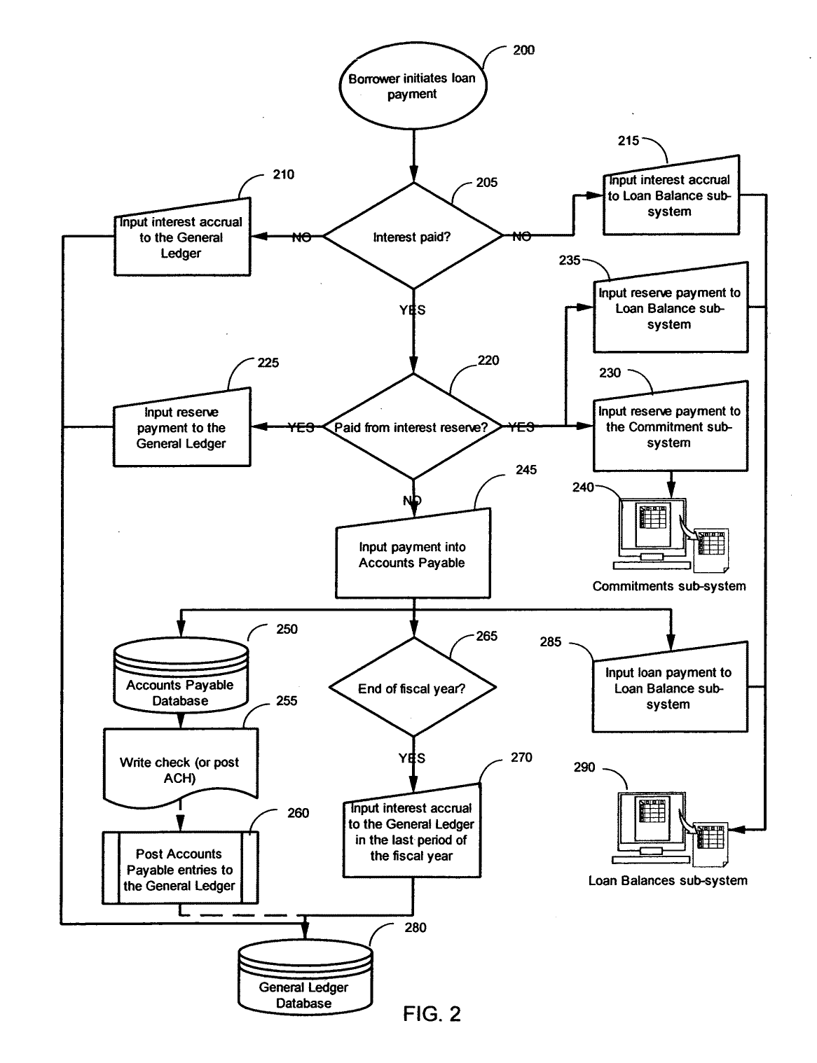

In overview, the present invention deviates from the current practiced art in the borrower's processing of loan payments of principal and/or interest in that the method and system bifurcates the handling of interest and payments. FIG. 1A illustrates the recording of interest transactions and FIG. 2A illustrates the recording of payment transactions. In the current art, borrower's treat the process of applying interest and making payments as the same.

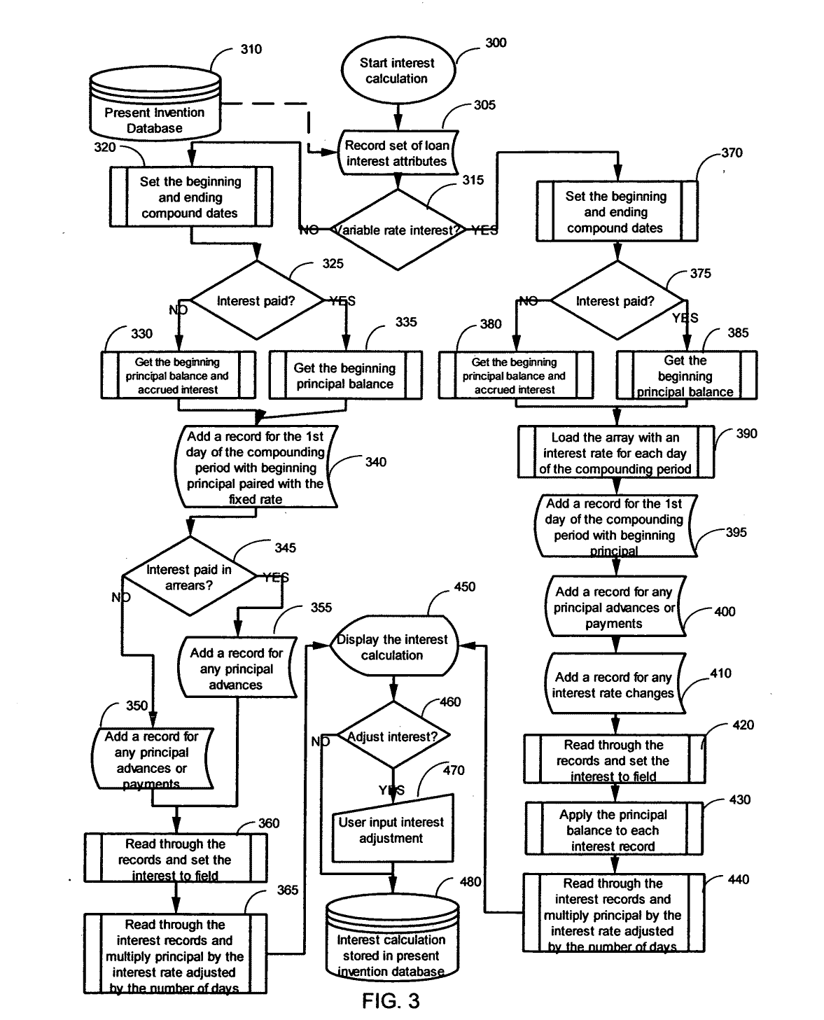

In FIG. 1A, block 10, the user in the present invention selects a loan for processing the interest calculation. The process in block 20 begins by retrieving interest attributes from the invented database as shown in block 30. The process in block 20 is illustrated in greater detail in FIG. 3. The process in block 20 retrieves interest attributes from the present invention database such as compounding period begin date, compounding period end date, interest rate, days in the year, principal transactions during the compounding period, and the principal balance at the beginning of the compounding period. In the case of a variable interest rate loan, the index, spread, interest rate limits are passed. The process in block 20 uses the database information to calculate the interest that should be charged by the lender during the compounding period. The user views the interest calculation in block 40. In block 50, the user may choose to accept the interest calculation from block 20 or can manually adjust it as shown in block 60. Once the user accepts the interest calculation, as in block 50, the process will retain the calculations in the present invention database as illustrated in block 30. In block 70, the process creates general ledger interest accrual entries to be automatically posted to the user's general ledger database, as shown in block 80. It should be noted here that the user's general ledger database is a separate system from the present invention and no claims are made to it, but is shown here for convenience of understanding the data transfer from the present invention.

FIG. 1B represents a separate process for the user to initiate payments. In block 100, the user selects a loan eligible for payment. Payment attributes are passed to the process in block 110 from the present invention database in block 120, such as scheduled payment amount, payment due date, interest accrued from the process in FIG. 1A, and escrow payments if any. The user views the payment to be made in block 130. In block 140, the user may choose to accept the payment amount or can manually adjust the payment to be made, as shown in block 150. Once the user accepts the payment calculation, as in block 140, the process will retain the payment amounts for principal, interest, and escrow amounts if any in the transaction tables and current balances table found in the present invention database, as shown in block 120. In block 160, the process creates accounts payable payment entries to be automatically transferred to the user's accounts payable database, as shown in block 170. It should be noted here that the user's accounts payable database is a separate system from the present invention and no claims are made to it, but is shown here for convenience of understanding the data transfer from the present invention.

FIG. 2 illustrates how the user processes loan payments as most commonly practiced in the current art. In block 200, the user initiates the process of payment of a singular loan perhaps with a statement received by the lender detailing the amounts of principal, interest, and escrow amounts, if any due. The user decides if interest is to be paid, as shown in block 205. If not and the loan accrues interest without requiring a payment, the user enters the interest accrued during the compounding period into its general ledger system and the accrued interest is retained, as in block 210. The user then may change the accrued interest amount in its loan balance sub-system, as shown in block 215. The accrued interest balance is retained in the loan balance sub-system, as shown in block 290. If interest is to be paid, from block 205, the user must decide if an interest reserve balance exists to pay the interest (block 220). If yes, the user will input and add the interest amount to the principal balance for the loan in its general ledger, as shown in block 225 and the data retained in the general ledger as shown in block 280. The user then inputs the interest paid from reserve and updates the interest reserve balance in its commitments sub-system, as shown in block 230 with the data retained in commitments sub-system as shown in block 240. The user then updates the new principal balance in its loan balance sub-system, as shown in block 235 with the data retained in the loan balance sub-system as shown in block 290. If an interest reserve does not exist, the user will input the principal, interest, and escrow amounts, if any into its accounts payable system, as shown in block 245 with the data retained in block 250. The user then either writes a check to the lender or records an ACH transaction as shown in block 255. The entries posted to the accounts payable database are automatically transferred to the user's general ledger database, as shown in block 260 with the data retained in block 280. The user then inputs the loan payment to update the loan balance in its loan balance sub-system, as shown in block 285 with the data retained in the loan balances sub-system (block 290). If the loan payment is to be made for the last period in the user's fiscal year (block 265), then the user inputs an interest accrual entry its general ledger in the last period of its fiscal year, as shown in block 270 with the data retained in block 280.

FIG. 3 illustrates in detail the process to calculate interest as initially described in block 20 from FIG. 1A. After the user selects a loan to calculate interest for the compounding period, the process retrieves a set of interest attributes, shown in block 305 from the present invention database, as shown in block 310. The process determines whether the loan is has a variable rate of interest or fixed, as shown in block 315. If the interest rate is fixed, the process sets the beginning and ending compounding dates, as in block 320. Block 325 determines if interest is to be paid or accrued. If interest is not paid (accrued), block 330 will get the balances of principal and accrued interest and add them together. In block 335, if interest is to be paid, then only the beginning principal balance is retrieved. In block 340, a record is added to the interest transaction table for the first day of the compounding period with the beginning principal (and accrued interest in the case of block 330) paired with the fixed interest rate. The process will determine in block 345 if interest is to be paid in arrears (simple interest) or if interest is to be charged on accrued interest. If not simple, then for each principal advance or principal payment is made, a record is added to the interest transaction table with the beginning principal balance adjusted for the principal advance or payment. If simple, then add a record in the interest transaction table for only the principal advances made during the compounding period (block 355). In block 360, the process reads through all the records in the interest transaction table for the compounding period in descending order by date applying the “interest to” field from the date of the previous record minus one day. The first record contains the date of the beginning of the compounding period. Each additional principal transaction contains an “interest from” date. The last record “interest to” field will be set to the ending date of the compounding period. In block 365, the interest record set is read through again calculating interest. For each record, the principal balance is multiplied by the fixed interest rate adjusted for the number of days and adjusted for a 360 or 365 year.

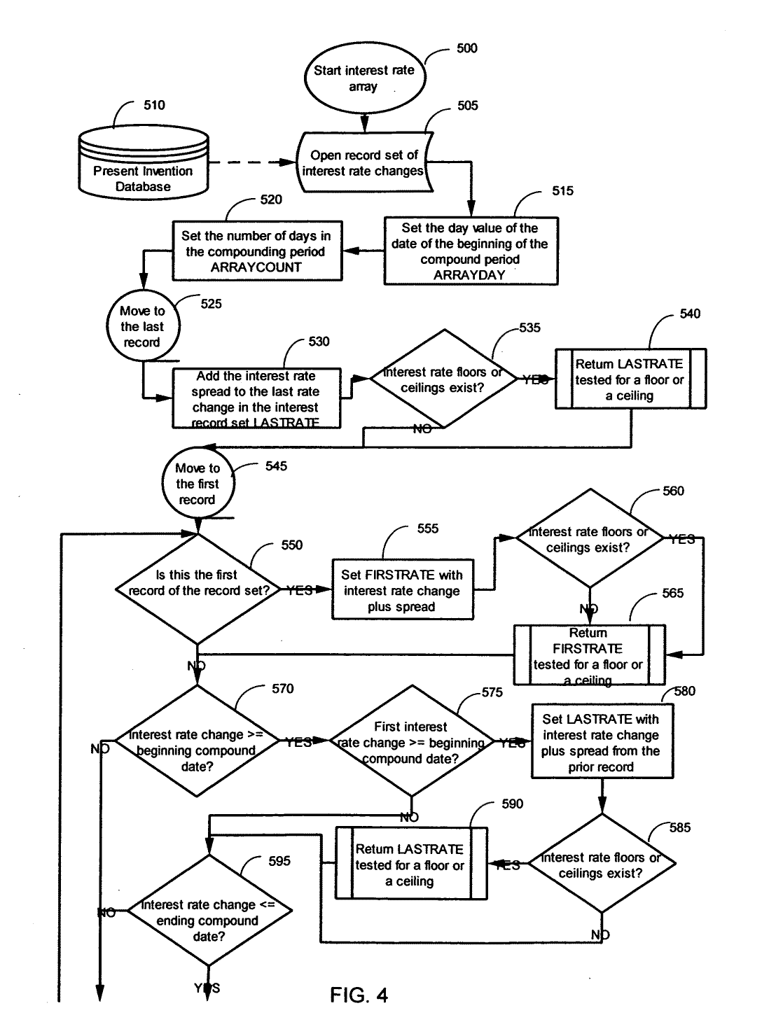

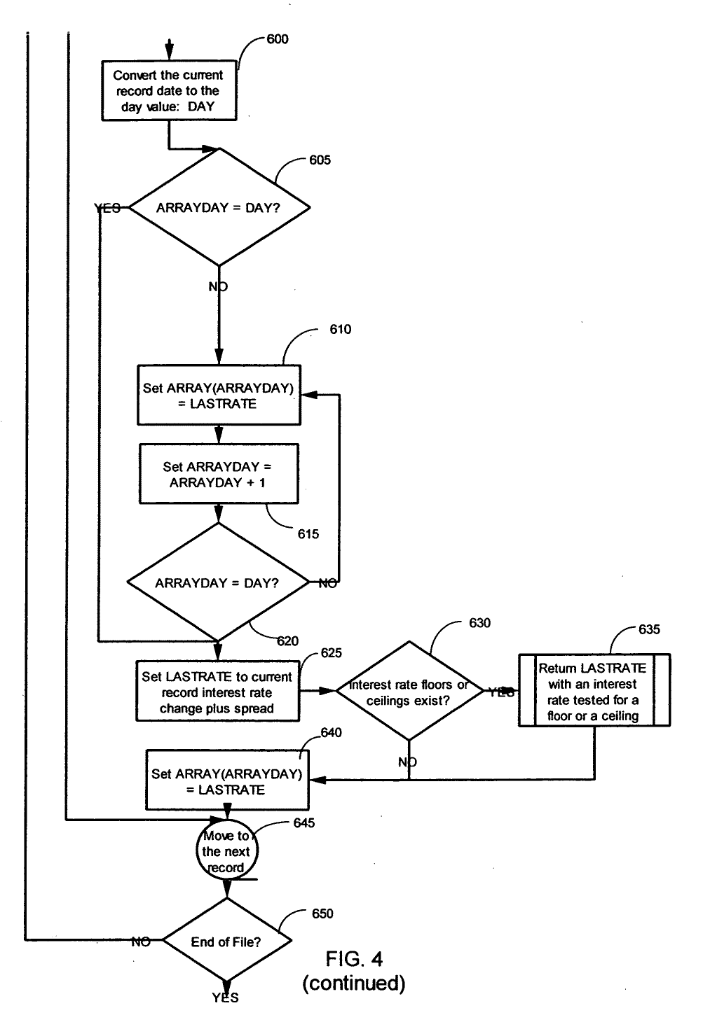

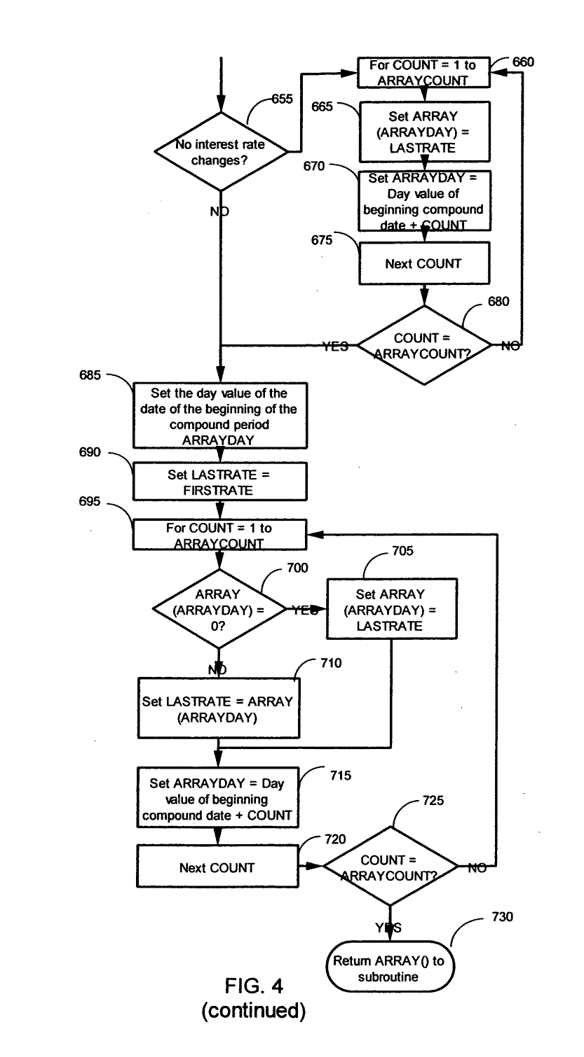

Returning to block 315, if the interest rate is variable the process continues to block 370 where the beginning and ending compounding dates are set. Block 375 determines if interest is to be paid or accrued. If interest is not paid (accrued), block 380 will get the balances of principal and accrued interest and add them together. In block 385, if interest is to be paid, then only the beginning principal balance is retrieved. In block 390, the process runs a subroutine to build an array containing an interest rate for each day in the compounding period. The array procedure is illustrated in detail on FIG. 4. The process continues in block 395 by adding a record to the interest transaction table for the first day of the compounding period and with the beginning principal balance obtained from either block 380 or 385. This record will be matched with the interest rate loaded in the array from block 390 for that particular date. In block 400, the process adds a record to the interest transaction table for any principal advances or payments again matching the record with the interest rate loaded in the array in block 390 for the particular date of the advance or payment. The process continues to block 410 where the index table is read and any changes in the interest rate index occurring during the compounding period are added to the interest transaction table. The process continues at block 420 where the interest record set is read through, in a descending order by date, setting the “interest to” field with the date of the previous record minus one day. The interest record set is read through in block 430 testing each record for a null value in the principal balance field. If null, the field is set with the principal balance from the previous record. If not null, a variable is set to carry the principal balance to the next record. In block 440, the interest record set is read through one final time calculating the interest. For each record, the principal balance is multiplied by the variable interest rate found within that record, adjusted for the number of days which is the difference between the “interest to” and “interest from” fields adjusted for a 360 or 365 year.

The process ending at block 365 in the case of a fixed interest rate and the process ending at block 440 in the case of a variable interest rate converge at block 450. The interest calculation is displayed to the user's screen. The user then can compare the calculated value with the calculation made by the lender as shown on the loan statement. In block 460, the use decides whether to adjust the interest calculation or not. If not, the process stores the interest calculation to the permanent transaction table and the balance table, as shown in block 480. In block 470, the user may adjust the interest calculation after which the process stores the interest calculation to the permanent transaction table and the balance table, as shown in block 480.

The interest rate array first described in summary in block 390 of FIG. 3 is described in detail in FIG. 4. The variable rate interest calculation subroutine which begins in block 370 of FIG. 3 calls the subroutine to load the interest rate array in block 390 which begins in block 500 of FIG. 4. The purpose of the interest rate array is to make available to the variable rate interest calculation subroutine the correct interest rate for any date during the compounding period. From FIG. 3, a correct interest rate is needed for any change in the index rate, any principal advance, and any payment made during the compounding period. This process opens the appropriate record set of interest rate index changes, as shown in block 505 with the data arriving from the present invention database, as shown in block 510. In block 515, the first day of the compounding period is set (ARRAYDAY) and in block 520, the number of days in the compounding period is calculated (ARRAYCOUNT). The result is used to dimension the array. In block 525, the process moves to the last record in the record set. The interest rate spread is added to the index value found in block 525 and the LASTRATE variable is set with the result (block 530). The process determines if an interest rate floor or ceiling exists for the singular as in block 535. If either an interest rate floor or ceiling exists, the process runs a subroutine in block 540 to return an interest rate tested for a floor or a ceiling. If the interest rate exceeds the ceiling, the ceiling rate is returned and set as LASTRATE. If the interest rate is below the floor, the floor rate is returned and set as LASTRATE. The process then moves to the first record of the index record set (block 545). If this is the first record of the record set (block 550), FIRSTRATE is set with the index value plus the spread (block 555). Again, if an interest rate floor or ceiling exists, FIRSTRATE is tested for a floor or ceiling (block 560) and FIRSTRATE is set to the correct rate (block 565). If the interest rate for the current index record is greater or equal to the beginning date of the compounding period (block 570) and if this is the first interest rate change after the beginning date of the compounding period (block 575), then set LASTRATE with interest rate change plus the spread from the prior record (block 580). The process needs to retain the last rate before the compounding period starts in the event there is an interest rate change during the compounding period, but does not occur exactly on the first day of the compounding period. Again, test this rate for a floor or a ceiling (block 585) and set LASTRATE with the correct rate (block 590). If it is not the first interest rate change after the beginning of the compounding period (block 575), then continue to block 595. If the date of the interest rate change is not greater or equal to the beginning date of the compound period continue to block 645 to get the next record. At block 595, the process determines if the current record interest rate change date is less than or equal to the ending date of the compounding period. If not, then the process will move to the next record in block 645 to get the next record. If yes, then the process will convert the date value of the interest index change to a day value (DAY), as shown in block 600. The process will determine if ARRAYDAY is equal to DAY (block 605). For example, if the first day of the compounding period is the 1^{st} of the month, ARRAYDAY will be 1. If there is an interest rate index change on the 3^{rd} of the month, then DAY will be 3. If ARRAYDAY and DAY are equal, LASTRATE will be set to current record interest rate index change plus the spread (block 625). Again, if an interest rate floor or ceiling exists (block 630), then LASTRATE is tested and set with the correct rate (block 635). At block 640, the Array is loaded for ARRAYDAY with LASTRATE [ARRAY(ARRAYDAY)=LASTRATE]. The process then proceeds to block 645 to get the next interest index change record. If in block 605, ARRAYDAY does not equal DAY, then the Array is loaded with LASTRATE [ARRAY(ARRAYDAY)=LASTRATE] shown in block 610. In block 615, ARRAYDAY is incremented by one [ARRAYDAY=ARRAYDAY+1]. Block 620 will test if ARRAYDAY equals DAY. If not, the process loops back up to block 610 to load the array, increment ARRAYDAY, and test again if ARRAYDAY=DAY. Once ARRAYDAY equals DAY, the process continues at block 625, to set LASTRATE, check for a floor or a ceiling, and load the array with LASTRATE. At block 645, the process moves to the next record and block 650 tests for an end of file condition. If not the end of the file, the process loops back up to block 550 and continues to load the array until the end of file condition exists. Once all the records in the interest rate index record set have been read, the process checks if there have been no interest rate index changes in block 655. If there have been no changes, the process loops through and loads the entire array with the value of LASTRATE, as shown in blocks 660 through 680. In this condition, LASTRATE is the last known interest rate before the compounding period. The process continues in block 685 where the value ARRAYDAY is reset to the day value of the beginning of the compounding period. LASTRATE is reset to FIRSTRATE at block 690. Beginning in block 695, the array is read through from 1 to ARRAYCOUNT (the number of days in the compounding period) and checks each value for a null value (block 700). If the process finds a null value (block 705), the array for that day is loaded with LASTRATE, which is the interest rate from the previous day (block 710). ARRAYDAY, in block 715 is incremented by adding COUNT to the date value of the beginning of the compounding period and then converting the date value to a day value. COUNT is the number of times the process has looped. Adding the COUNT to the date is necessary in the case when the beginning of the compounding period does not fall on the first. For example, if the beginning of the compounding period falls on the 3^{rd}, then the loop needs to start with 3 then to 4, 5, 6, and so on until the end of the month approaches where it loops with 29, 30, 31, 1, and then end with 2. In this example, this is for a month with 31 days. By incrementing from a date value, it can adjust for any length of month, including a 29 day February leap year. ARRAY( ) is returned to the calling subroutine in block 730 with an interest rate loaded for each day in the compounding period. If the calling subroutine calls for an interest rate for say the 15^{th} of the month, it merely needs to refer to ARRAY(15) to get the correct rate.

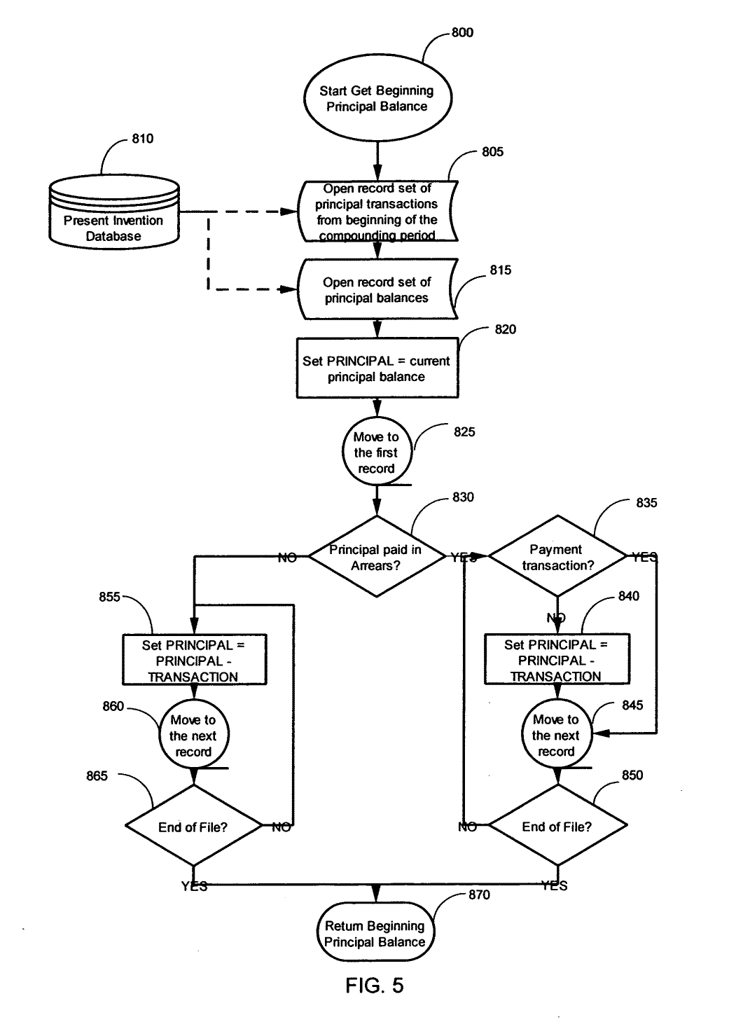

FIG. 5 illustrates the process of obtaining the beginning principal balance for use in the interest calculation subroutine. From FIG. 3, blocks 330, 335, 380, and 385 the interest calculation subroutine calls this process and begins in block 800. A record set of all the principal transactions (block 805) for a singular loan are obtained from the transaction tables found in the present invention database shown in block 810. In block 815, the current principal balance is obtained for the same singular loan. The variable PRINCIPAL, in block 820 is set to the value of the current principal balance found in block 815. The process, in block 825 then gets the first record of the record set found in block 805. If the loan attributed is set to “principal paid in arrears” as shown in block 830; the process continues at block 835 where the record is determined if a payment transaction. If the record is a payment transaction, it is ignored and the next record is retrieved in block 845. If the record is not a payment (perhaps an advance), then the transaction amount is subtracted from PRINCIPAL and PRINCIPAL is reset to the new value (block 840). The next record is obtained in block 845. The process determines if an End of File (last record in the record set) condition is met in block 850. If not, the process loops back up to block 835 to determine if the new record is a payment transaction. If the End of File condition is reached in block 850, the result of the beginning principal balance for the compounding period is returned to the calling subroutine. If the principal payment is not paid in arrears at block 830, regardless of the type of principal transaction, the transaction amount is added or subtracted from or to PRINCIPAL and PRINCIPAL is reset to the new value (block 855). The next record is obtained in block 860. If not, the process loops back up to block 855 to add or subtract the new transaction amount to or from PRINCIPAL. After the End of File condition is met the value of PRINCIPAL is returned to the calling subroutine, as shown in block 870.

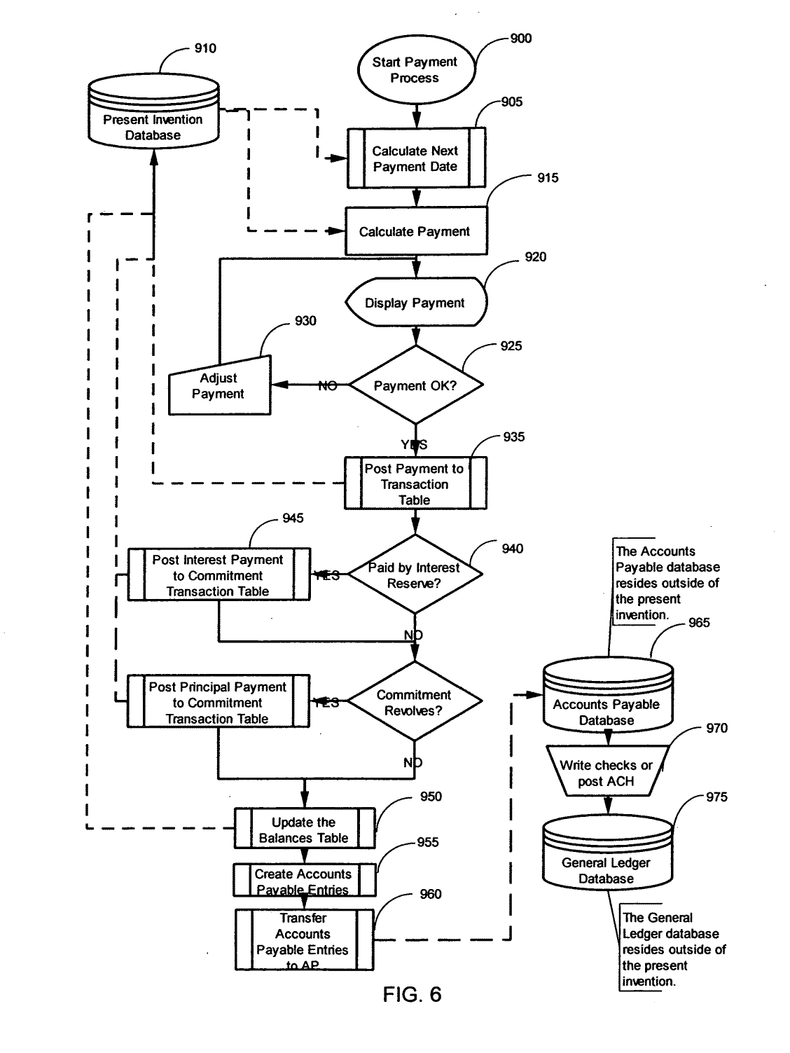

FIG. 1B is a simplified illustration of the payment process of the present invention. FIG. 6 further details the payment process. The process begins in block 900 when the user initiates a loan payment for a singular loan. In block 905, the process calls a subroutine to calculate, with data attributes from the present invention database in block 910, the next scheduled payment date. In block 915, the process calculates the next scheduled payment from data attributes from the present invention database in block 910 such as scheduled payment, accrued interest, interest reserve if any, escrow payment if any, due date, and loan number. The calculated payment is displayed to the user in block 920 in total and by line detail (i.e. principal, interest, and escrow amounts). If the payment is incorrect (block 925), the user can adjust it as in block 930. Once the payment is correct, the user posts the payment (block 935). The process posts the payment transaction to the transaction table of the present invention database (block 910). In block 940, the process determines if there is available interest reserve to pay the accrued interest. If so, the commitment transaction table is updated (block 945) to reduce interest reserve commitment for the amount of the accrued interest. The process continues to block 950 to determine if the commitment issued by the lender is revolving, as in a line of credit. If so, a record is added to the commitment transaction table adding back commitment (block 955). If not, the process continues to block 960, where it will update the balances table in the present invention database (block 910). The principal balance will be reduced (unless paid by interest reserve), the accrued interest will be reduced, and the escrow balances will be increased. If the process moved to block 945, the interest reserve balance will be updated. If the process moved to block 955, the commitment balance will be updated. The process moves to block 965 where the accounts payable entries are created. The process transfers the accounts payable entries (block 970) to the user's accounts payable database (block 975). This transfer is done by formatting the entry data into a format acceptable by the user's accounts payable system. A macro is automatically run to accomplish the import. After the entries have been imported into the user's accounts payable database, the user may write a check or otherwise post an ACH for the payment in block 980, after which the payment entries are posted to the user's general ledger database (block 985). It should be noted here that neither the user's accounts payable database nor general ledger database resides within the scope of the present invention. It is shown on FIG. 6 and described herein to aid in comprehending the data transfer between the present invention and the user's other financial systems.

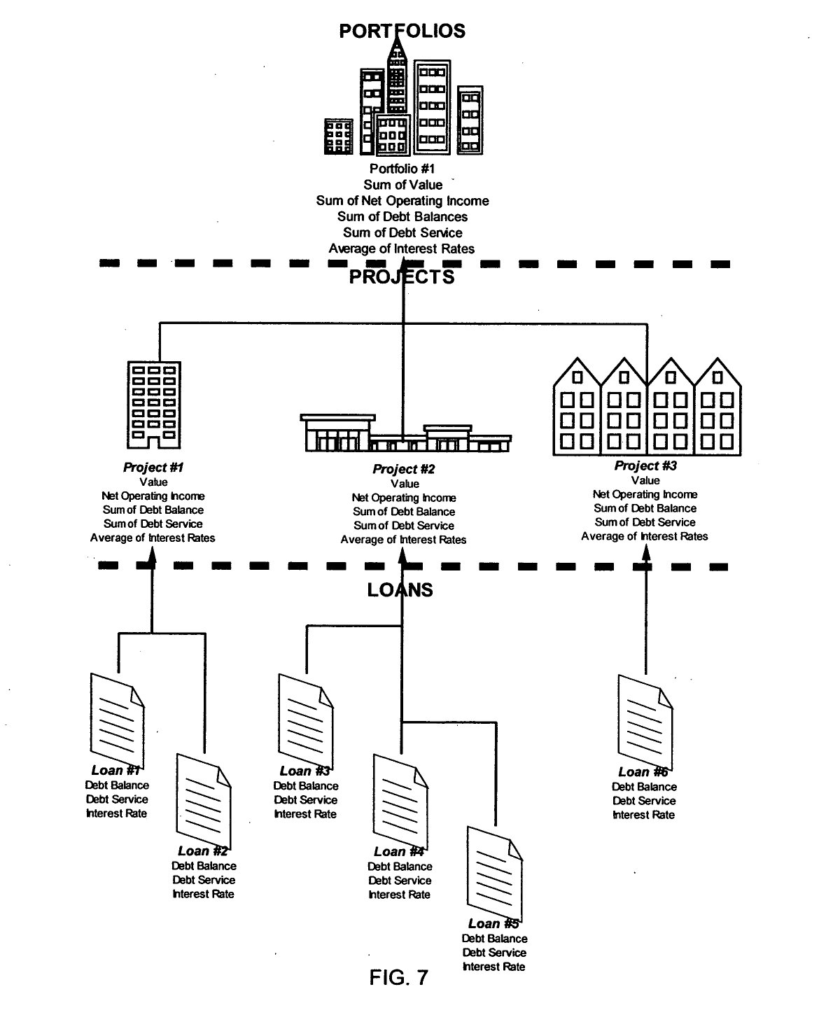

FIG. 7 is an illustration the method employed to create portfolios as claimed in claim 30. The user can input information regarding its projects. Each loan can be assigned to a project with the order of priority. The user can create a portfolio or portfolios. Each project can be assigned to a portfolio or portfolios. As shown on FIG. 7 for each loan linked to a project, the debt balance, the annual debt service, and the current loan interest rate flows up to and is summarized at the project level. The interest rates for multiple loans are summarized on a weighted average basis. For each project that is linked to a portfolio, the debt balance, the annual debt service, and the weighted average interest rate is further summarized at the portfolio level. In addition, the value of the project and the income of the project are summarized at the portfolio level. The present invention stores these five data points for each project historically by month. To summarize, the present invention stores:
Value of projects
Net Operating Income for the projects
Sum of the debt balances by project
Sum of the annual debt service by project (calculated forward)
Weighted average interest rate by project

These values can then easily be summarized by Portfolio.

With these five data points the following other indicators can be calculated and reported by project or portfolio for any point in time or trended over time graphically:
Equity: Value−Debt
Cash Flow: Net Operating Income−Debt Service
Rate of Capitalization: Net Operating Income/Value
Loan to Value: Debt/Value
Debt Service Coverage Ratio: Net Operating Income/Debt Service
Return on Equity: Cash Flow/Equity
Return on Assets: Cash Flow/Value
Weighted Average Cost of Capital: Weighted Average Interest Rate

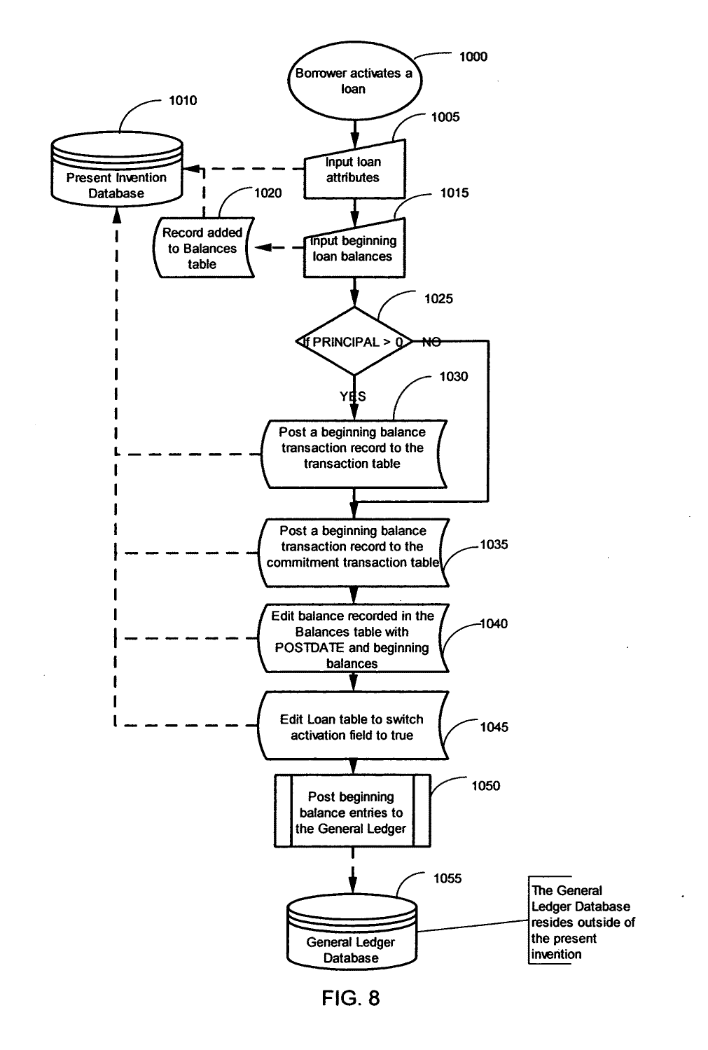

FIG. 8 illustrates the process of activating a loan in the present invention. In block 1005, the user inputs all the attributes to describe the singular loan. The attributes are grouped as follows:
Maturity. Maturity contains the origination date, the maturity date, extension options and dates if applicable, and prepayment penalty details.
Payment. The payment attributes include the method of payment, due date day, scheduled principal or payment, escrow payments, and balloon payment attributes.
Interest. The interest attributes include fixed or variable interest rate, index, spread, interest rate limits, interest days/year, compounding period, and compounding day,
General Ledger. For each type of payment, the user enters the corresponding general ledger account from its general ledger system for use in integration. In the instance where a loan is capitalized in a job cost system, the job and cost code may be entered.
Commitment. The original loan commitment, initial draw commitment, initial interest reserve amounts, and any revolving or resting requirements.
Loan Documents and Notes. Any notes that a user would like to retain. Electronically stored loan documents and amendments may be stored here.

The loan attributes are stored in the present invention database in block 1010. To activate the loan, the user inputs the beginning balances of principal, accrued interest, escrow balances, and an effective date. This input creates a record in the balances table in block 1020 which is retained in the database of block 1010. If the user inputs a beginning balance for the loan (block 1025), the process in block 1030 will add a beginning balance transaction record to the Transaction table which is retained in the database of block 1010. If the user does not input a beginning balance, the process continues to block 1035. At block 1035, a beginning balance record is added to the commitment transaction table which is retained in the database of block 1010. In block 1040, the record added at block 1020 is edited to record the POSTDATE (effective date of the loan). The loan table record for the singular loan is edited to change the activation field from false to true. In block 1050, the general ledger entries with the beginning balances of the loan are created, formatted for import into the user's general ledger system, and automatically imported into the user's general ledger system, as shown in block 1055. It should be noted here that the user's general ledger database does not reside within the scope of the present invention. It is shown on FIG. 8 and described herein to aid in comprehending the data transfer between the present invention and the user's other financial systems.

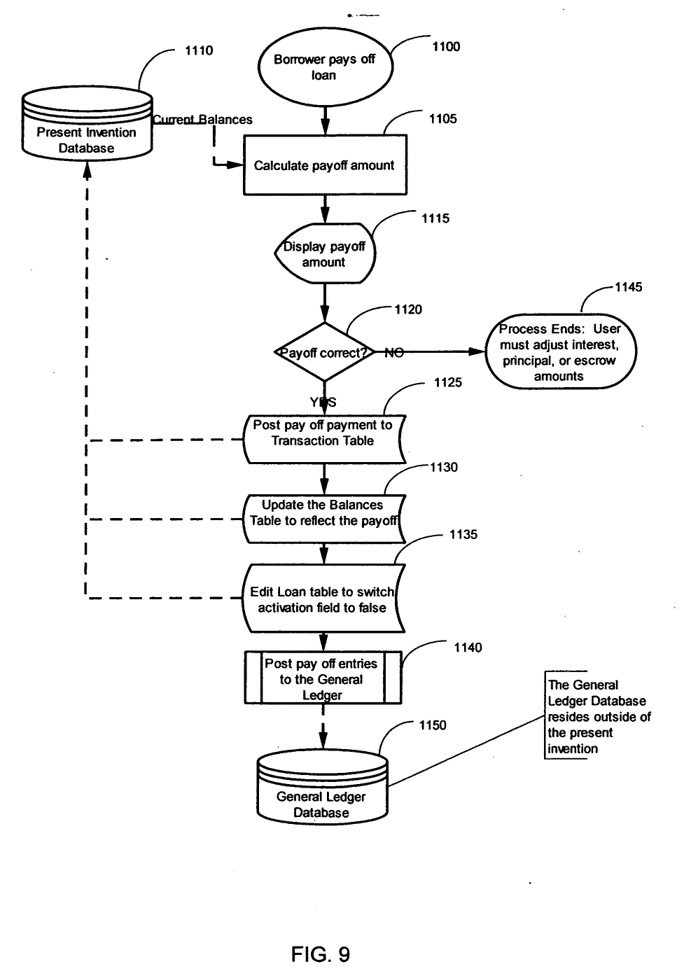

FIG. 9 illustrates the process of paying off a loan. In this process, the loan balances in the balances table must be reduced to zero and the loan balances found in the user's general ledger system must be reduced to zero. The process begins in block 1100 with the user opening a form in the system. The process calculates from the current balances obtained from the present invention database of block 1110 and returns the amount that should be paid off as of the payoff date in block 1105. The payoff calculation is displayed to the user's screen and illustrated in block 1115. If the payoff amount is not correct (block 1120), that is it may not match with the lender's demand for payment, the closing statement, or other payoff documents, the user must terminate the process as in block 1145 and adjust the balances of the loan from within the system. Once adjusted, the user may re-initiate the payoff process. If the payoff amount is correct (block 1120), the process continues to block 1125 where a payoff payment is recorded in the transaction table and retained in the database of block 1110. Then the process updates the balances table found in the database of block 1110 to reflect the payoff payment presumably reducing all balances to zero (block 1130). The activation field of the loan table maintained in the database of block 1110 is switched from true to false in block 1135. In block 1140, the procedure to post the payoff entries to the user's general ledger system is invoked and the entries are transferred to the general ledger in block 1150. It should be noted here that the user's general ledger database does not reside within the scope of the present invention. It is shown on FIG. 9 and described herein to aid in comprehending the data transfer between the present invention and the user's other financial systems.

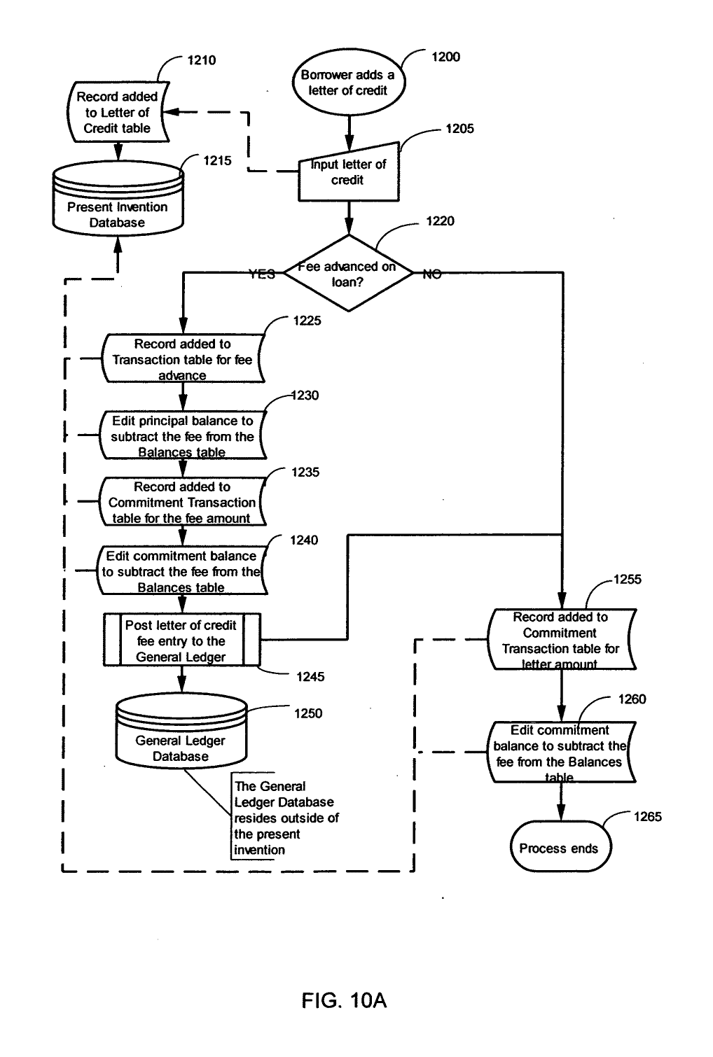

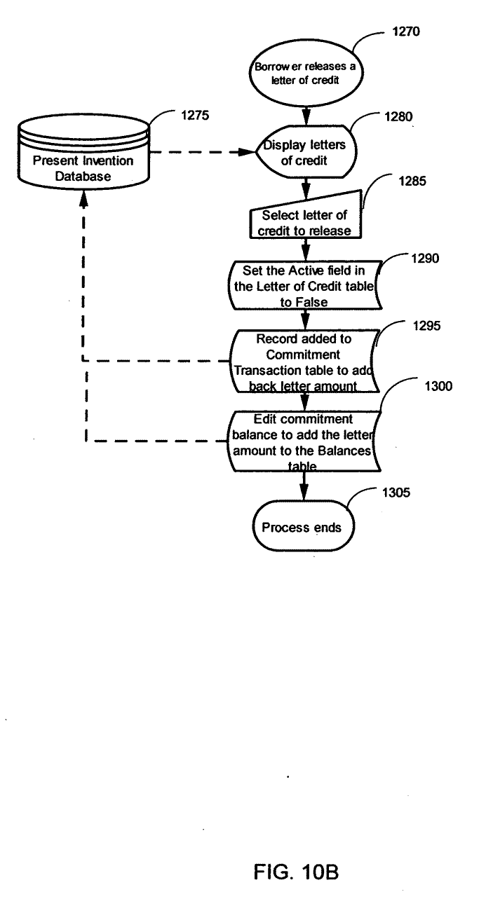

In certain instances in the case of construction or development financing, letters of credit may be issued by the lender on behalf of the borrower to benefit a third party. The amount of the letter of credit will reduce the amount of the lender's commitment to lend. In the present invention as claimed in claim 5, the user can enter into the database letters of credit which are linked to a singular loan obligation issued by a lender. FIG. 10A illustrates in detail the process in which a letter of credit is added into the present invention. The process begins in block 1200 by opening a form for data entry. In block 1205, the user enters the data attributes regarding the letter such as the origination and expiration dates, the amount, the beneficiary, description, and fee if any. A record (block 1210) is added to the present invention database as shown in block 1215. The process, in block 1220 determines if the fee entered in block 1205 is to be advanced against the loan. If yes, then a principal transaction record is added to the transaction table (block 1225). The principal balance for the singular loan is updated to reflect the addition of the fee (block 1230). A commitment transaction record is added to the commitment transaction table subtracting the amount of the fee from the remaining commitment to lend (block 1235). The commitment balance is updated to subtract the fee amount in the balances table (block 1240). The general ledger entries for the fee are created in block 1245 and transferred to the user's general ledger database in block 1250. It should be noted here that the user's general ledger database does not reside within the scope of the present invention. It is shown on FIG. 10A and described herein to aid in comprehending the data transfer between the present invention and the user's other financial systems. The process continues in block 1255. If a fee is not to be advanced against the loan as in block 1220, the process continues in block 1255 where a record is added to the commitment transaction table for the letter of credit amount. The commitment balance is updated to subtract the letter of credit amount in the balances table. The process ends in block 1265.

At the time that the letter of credit expires or the letter of credit beneficiary has released the letter of credit, the borrower can release a letter of credit from within the present invention commencing in block 1270 of FIG. 10B. The plurality of letters of credit is displayed to the user in block 1280 with the data arriving from the present invention database as illustrated in block 1275. The user selects which letter of credit to release in block 1285. The active field in the Letter of Credit table is changed from true to false in block 1290. A recorded is added to the Commitment Transaction table to add back the letter of credit amount to the available commitment to lend as shown in block 1295. The commitment balance is updated to add the letter of credit amount in the Balance table in block 1300. The process terminates in block 1305.

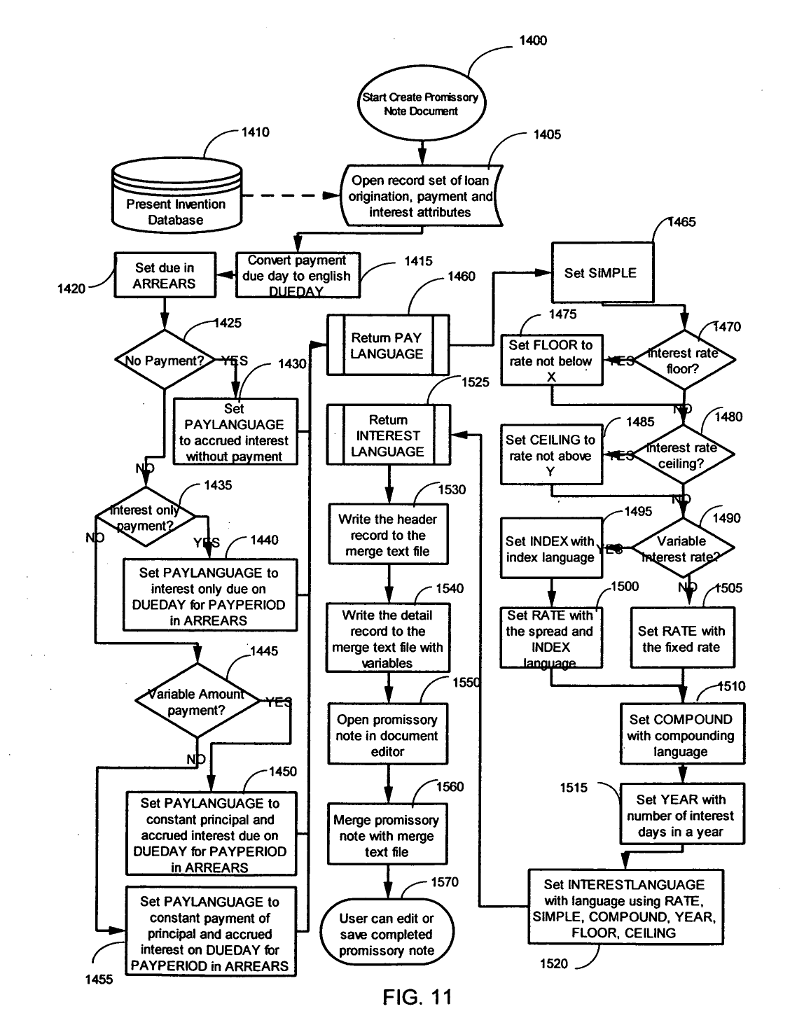

In certain instances, the user of the present invention will be not only the maker of the loan, but will also prepare the loan documentation. This may be the case in the instances of shareholder or member and intercompany loans made to the borrower. The present invention can retrieve attributes from the database regarding origination and maturity dates, original commitment, borrowing entity, lending entity, interest attributes, and payment attributes for the purpose of creating the promissory note in the user's existing document editor. The user may then print and save the automatically created promissory note. FIG. 11 illustrates the process of creating promissory notes from within the present invention. The process begins in block 1400 after the user selects a singular loan for processing. The process opens a record set of loan attributes (block 1405) from the present invention database (block 1410). In block 1415, the process converts the integer stored payment due date to a string variable (DUEDAY). For example, if a loan is due on the 1^{st} day of each calendar month, the “1” is converted to “1^{st}”. The ARREARS language variable is set in block 1420. If the payment is due in arrears, ARREARS equal “due in arrears”. If not the string is left blank. The process determines in block 1425 if a scheduled payment is required. If not, the payment language (PAYLANGUAGE) is set in block 1430 to read that interest will accrue without a payment and the process continues to block 1460. If a payment is required, the process at block 1435 determines if it is an interest only payment. If so, then set the payment language to read that interest only is due on the due date, for a certain payment period, and if paid in arrears and continue to block 1440. If not interest only, the process determines in block 1445 if the payment is a constant payment or a variable payment. A variable payment means that a constant payment of principal is due plus the accrued interest from the prior compounding period is due. If so, the payment language is set to read that a constant payment of principal plus the accrued interest from the prior compounding period is due on the DUEDAY for the PAYPERIOD and paid in ARREARS (block 1450) and the process continues on to block 1460. If not, then the payment is a constant payment equal to the prior compounding period's accrued interest with the remainder applied to principal. The payment language is set in 1455 to read that a constant payment of principal and accrued interest is due on the DUEDAY for the PAYPERIOD and paid in ARREARS. The process converges on block 1460 where the payment language is set for the type of payment required. Next the process moves to block 1465 where it will determine the interest language required to be published in the promissory note. The variable SIMPLE is set to “on a simple basis” if the interest is simple interest. It will be blank or null, if not. In block 1470, the process determines if the interest has a floor or lower limit that is charged. If so, the string variable FLOOR is set in block 1475 with language to read that the interest rate will never be less than the floor variable. If not string variable FLOOR is left as null and the process continues to block 1480 where the process determines if an interest rate ceiling or upper limit on interest that may be charged exists for the loan. If so, the string variable CEILING is set in block 1485 with language that reads that the interest rate will never be greater than the ceiling variable. If not the CEILING string variable is left as null and the process continues to block 1490 where the process determines if the interest rate is fixed or variable. If the interest rate is variable, block 1495 will use the index attribute from the record set in block 1405 to create the INDEX language. RATE is set in block 1500 with the spread attribute from the record set in block 1505 and the INDEX language is added to it. If the interest rate is fixed, RATE is set in block 1505 with the fixed interest rate attribute obtained from the record set in block 1505 and language stating that the interest rate is a fixed rate. The process continues to block 1510 to set the compounding period to the string variable COMPOUND. In block 1515, the string variable YEAR is set which contains language as to how many days in the year interest will be charged. In block 1520, the string variables are all put together in sentences to describe how interest is calculated and for which periods. That string variable is returned to block 1525. The process in block 1530 creates a text file and writes a merge field header record which labels the variables to follow in the detailed record. The labels correspond to a previously created document file that has merge fields inserted within. In block 1540, the process writes the detail record in the text file created in block 1530 with the attributes obtained from the record set in block 1405 and the interest and payment language from blocks 1460 and 1525 respectively. The process interacts with the user's operating system to initiate a session of the user's document editor and opens the promissory note document (block 1550). In block 1560, the text file created in block 1530 is merged with the promissory note document initiated in block 1550. The process terminates in block 1570 with a promissory note exactly crafted from the loan attributes from the database translated into the correct language displayed in the user's document editor. The document may be saved or printed as the user desires. It should be noted here that the user's document editor is not a part of the scope of the present invention. It is illustrated in FIG. 11 and referenced herein to aid in comprehending the data transfer between the present invention and the user's other systems.

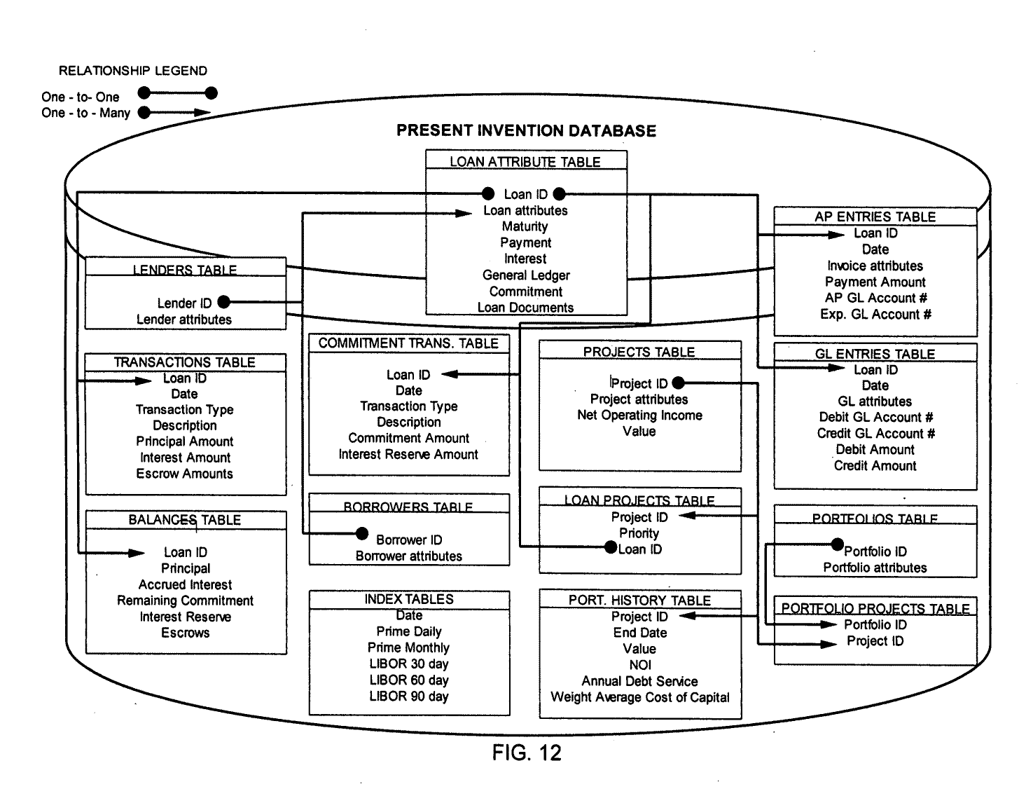

The database architecture for the present invention is summarized in FIG. 12. The rectangular boxes represent the data tables within the database. The connecting lines represent the index relationships between the data tables pointing either to or away from the indexed fields are one-to-many relationships. The connecting lines with terminations at both ends are one-to-one relationships.

Although the present invention has been described with the particular embodiments herein, many other variations, modifications, adaptations to other industries, and other uses will become apparent to those skilled in the art. Therefore, it is preferred that the present invention not be limited by the specific disclosure herein.

What is claimed is:

1. A computerized system combined with a database operating on non-specific computer hardware comprising a method to calculate the timing of and the amounts of a borrower's loan transactions to its plurality of lenders for the plurality of its loan obligations wherein said calculated periodic payments are initiated by the system to the plurality of its lenders for each of its plurality of loan obligations wherein said transactions are retained in the database.

2. The database recited in claim 1 is further comprised of:
a) a table to maintain a record for each of a borrower's plurality of loan obligations which retains a current balance amounts of the outstanding principal, unpaid accrued interest, a plurality of escrow accounts maintained by the lender, the lender's commitment to lend, and interest reserve;
b) a plurality of loan transaction tables to retain a history of the loan transactions comprised of principal, interest, escrow payments, other amounts, lender's commitment to lend, and interest reserve;
c) a table to retain the loan attribute data entered by the borrower for each of its plurality of loans including but not limited to the fields of data for: origination and maturity date, payment period, payment due date, principal paid in arrears (yes or no), payment type (interest only, constant payment, or constant amortization), payments to escrow accounts, payment changes (amount and/or type), interest rate type (fixed or variable), interest rate, spread, interest rate floor, interest rate ceiling, interest calculation type, interest compounding period, interest compounding day, simple interest (yes or no), interest compounding periods, general ledger account numbers, job cost attributes, original loan commitment, draw commitment, interest reserve commitment, and revolving commitment (yes or no);
d) a plurality of interest rate index tables containing interest rate index changes of widely accepted lending indexes;
e) a table of assets; and
f) a table of portfolios.

3. The computerized system recited in claim 1 is further comprised of a user interface to enter and maintain the plurality of letters of credit issued by a lender to third party beneficiaries using and releasing the lender's remaining commitment to lend by posting a transaction record to the commitment transaction table and updating the balance of the commitment to lend.

4. The computerized system recited in claim 1 is further comprised of a user interface to commit a beginning loan balance or principal advance made by a lender to a borrower for a particular loan obligation to the loan transaction tables and update the outstanding principal balance record.

5. The computerized system and database recited in claim 1 is further comprised of a process to periodically update the interest index tables by downloading interest rate changes from an interest rate index publishing server via an internet connection.

6. A process of the computerized system retrieving interest attribute data from the database recited in claim 1 is an algorithm to calculate interest for each of a borrower's plurality of loan obligations, comprising:
a) means for calculating and setting the compounding period begin and ending dates;
b) means for retrieving the current principal balances and principal transaction records retained in the database;
c) means for adding back or subtracting the principal transaction records from the current principal balance for the purpose of calculating a principal balance at the beginning of the compounding period;
d) means for determining if a fixed or variable interest rate is to be used;
e) means to retrieve an interest rate index value changes with associated data of change from the interest rate index tables;
f) In the case of variable rate, means for calculating the value of the variable interest rate using the index rate index value, adding or subtracting a spread, and applying an interest rate floor or interest rate ceiling, if any;
g) means to store an interest rate value for each day of the compounding period into an array dimensioned for the length of the compounding period;
h) means to pair an interest rate stored in said array to each change of the principal balance during the compounding period;
i) means to multiply the interest rate according to the calculation type with the associated principal balance for each date that the principal balance changed or an interest rate value changed; and
j) a means to store the interest calculation in a temporary table.

7. The process of claim 6 is further comprised of an interest interface for the borrower to view from the temporary table the interest calculation, adjust it to match the lender's calculation, if desired, by the borrower, and to post it to the transaction file and to increase the balance record.

8. The computerized system recited in claim 1 is further comprised of a payment interface to initiate a borrower's plurality of loan payments to its plurality of lenders utilizing the loan attribute data to calculate the amounts of and the timing of said payment.

9. The computerized system retrieving data from the database recited in claim 1 is further comprised of a process that converts the loan transactions stored in the loan transaction tables to a plurality of accounting entries by utilizing the general ledger loan attribute data, exporting said accounting entries from the computerized system and importing the same into the borrower's other financial systems, namely the accounts payable system, general ledger, and job cost system.

10. The computerized system retrieving data from the database recited in claim 1 is further comprised of a process combined with a report that utilizes the current principal balance and unpaid accrued interest balance, combined with the loan attribute data, including payment changes occurring on specific dates, if any, to amortize each of a borrower's loan obligations for the purpose of forecasting the amount of the outstanding principal balance at any future date.

11. The computerized system retrieving data from the database recited in claim 1 is further comprised of a process to create united states department of the treasury internal revenue service forms 1099-int interest income and 1096 annual summary and transmittal of united states information returns for distribution to lenders eligible of receipt of form 1099-int interest income.

12. The computerized system retrieving data from the database recited in claim 1 is further comprised of a computerized process utilizing the stored loan attribute data including payment amount, payment method, interest rate, method of calculating interest, compounding period, borrowing entity, lending entity, note origination date, note maturity date, and original principal commitment to create a promissory note document written with the exact language as the present invention will generate loan transactions.

13. A sub-system of the computerized system and database recited in claim 1 is further comprised of a set of user interfaces linking a borrower's plurality of loans secured by assets to its plurality of assets, further linking the plurality of the borrower's assets to user defined portfolios for the purpose of retaining in the database the linkage data while including data regarding the borrower's assets, namely but not limited to the asset value and the net operating income generated by the asset.

14. The sub-system recited in claim 13 is further comprised of an algorithm which generates historical records for each of the borrower's plurality of assets stored in the database tracking the performance of the borrower's assets and portfolios of assets as it relates to the carrying of the loan obligations, specifically including loan-to-value, debt service coverage ratio, cash flow, return on assets, return on equity, weighted average borrowing cost, and a quantitative measure of financial leverage.
